(19) United States
(12) Patent Application Publication
(10) Pub. No.: US 2006/0116313 A1
(43) Pub. Date: Jun. 1, 2006

(54) Compositions comprising tannic acid as corrosion inhibitor

(76) Inventors: Denise Geitz, Bethlehem, PA (US); Jennifer M. Rieker, Bethlehem, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/000,147

(22) Filed: Nov. 30, 2004

(51) Int. Cl. C11D 3/37

(52) U.S. Cl. 510/499

(57) ABSTRACT

Compositions for removing residue comprising tannic acid and/or salt thereof and methods using same are described herein.

### BACKGROUND OF THE INVENTION

Numerous steps are involved in the fabrication of microelectronic structures. Within the manufacturing scheme of fabricating integrated circuits selective etching of different surfaces of the semiconductor is sometimes required. Historically, a number of vastly different types of etching processes, to selectively remove material, have been successfully utilized to varying degrees. Moreover, the selective etching of different layers, within the microelectronic structure, is considered a critical and crucial step in the integrated circuit fabrication process.

Increasingly, reactive ion etching (RIE), is the process of choice for pattern transfer during via, metal line and trench formation. For instance, complex semi-conductor devices such as advanced DRAMS and microprocessors, which require multiple layers of back end of line interconnect wiring, utilize RIE to produce vias, metal lines and trench structures. Vias are used, through the interlayer dielectric, to provide contact between one level of silicon, silicide or metal wiring and the next level of wiring. Metal lines are conductive structures used as device interconnects. Trench structures are used in the formation of metal line structures. Vias, metal lines and trench structures typically expose metals and alloys such as Al, Al/Cu, Cu, Ti, TiN, Ta, TaN, W, TiW, silicon or a silicide such as a silicide of tungsten, titanium or cobalt. The RIE process typically leaves a residue (of a complex mixture) that may include re-sputtered oxide material as well as possibly organic materials from photoresist and antireflective coating materials used to lithographically define the vias, metal lines and or trench structures:

Corrosion inhibitors are typical components used in photoresist strippers and etch residue removers to protect metals including the relatively sensitive metals such as aluminum and titanium. Corrosion of these exposed metals on devices could lead to electrical failures and yield loss. Furthermore, the move to smaller and smaller feature sizes has made the selection of the inhibitor increasingly more important. As the feature size decreases, so too do the limits on allowable metal loss.

Another factor in choosing a corrosion inhibitor may be influenced by environmental and health concerns. Government and/or industrial regulations have increasingly become more stringent in the use of certain chemicals. This leads chemical manufacturers to look for more environmentally friendly or “green” chemicals.

It would, therefore, be desirable to provide a cleaning composition and process capable of removing residues such as, for example, remaining photoresist and/or processing residues, such as, for example, residues resulting from selective etching using plasmas and/or RIE without corroding the metal circuitry to any appreciable extent while taking into account environmental issues.

### BRIEF SUMMARY OF THE INVENTION

Compositions disclosed herein are capable of selectively removing residue such as photoresist and processing residue from a substrate without causing to any undesired extent corrosion of metal that might also be exposed to the composition.

In one aspect, there is provided a composition for removing residues comprising an organic amine and, optionally, an organic solvent, and at least about 0.5% by weight of tannic acid and/or salt thereof.

Also disclosed herein is a method for removing residues including photoresist and/or etching residue from a substrate that comprises contacting the substrate with the composition described herein.

### DETAILED DESCRIPTION OF THE INVENTION

A composition and process employing the composition are provided for selectively removing residues such as, for example, photoresist and/or processing residues such as the residues generated by etching particularly reactive ion etching. In a cleaning process involving articles such as substrates useful for microelectronic devices, typical contaminants to be removed may include, for example, organic compounds such as exposed photoresist material, photoresist residue, UV- or X-ray-hardened photoresist, C—F-containing polymers, low and high molecular weight polymers, and other organic etch residues; inorganic compounds such as metal oxides, ceramic particles from CMP slurries and other inorganic etch residues; metal containing compounds such as organometallic residues and metal organic compounds; ionic and neutral, light and heavy inorganic (metal) species, moisture, and insoluble materials, including particles generated by processing such as planarization and etching processes. In one particular embodiment, residues removed are processing residues such as those created by reactive ion etching.

Moreover, the photoresist and/or processing residues are typically present in an article that also includes metal, silicon, silicate and/or interlevel dielectric material such as deposited silicon oxides and derivitized silicon oxides such as HSQ, MSQ, FOX, TEOS and Spin-On Glass, and/or high-k materials such as hafnium silicate, hafnium oxide, barium strontium titanium (BST) Ta₂O₅ and TiO₂, wherein both the photoresist and/or residues and the metal, silicon, silicide, interlevel dielectric materials and/or high-k materials tend to come in contact with the cleaning composition.

The composition and method disclosed herein provide for removing residues without significantly causing corrosion of metal. In certain embodiments, the substrate may contain a metal, such as, but not limited to, copper, copper alloy, titanium, titanium nitride, tantalum, tantalum nitride, tungsten, titanium/tungsten, aluminum and/or aluminum alloys. The compositions disclosed herein may comprise an organic amine and optionally an organic solvent and at least about 0.5% by weight of tannic acid and/or salt thereof. In certain embodiments, the composition may contain from about 0.5 to about 25% of the tannic acid and/or salt thereof, or from about 0.5 to about 10% of the tannic acid and/or salt thereof or from about 0.5 to about 5% of the tannic acid and/or salt thereof. The general structure of tannic acid is a phenolic group (such as gallic acid) attached to the hydroxyl groups of a central polyol (generally D-glucose) through partial or complete esterification. The molecular weight varies depending on the number of phenolic groups attached. Examples of salts include ammonia and amine salts. The compostions typically have a pH of at least 7, more typically above 7 and even more typically at least about 9 and even more typically about 10 to about 12.

One or more organic solvents may be added to the compositions disclosed herein. These solvents may be used alone or in combination. Examples of some typical organic solvents are propylene glycol, tripropylene glycol methyl ether, 1,4-butanediol, propylene glycol propyl ether, diethylene glycol n-butyl ether (e.g., commercially available under the trade designation Dowanol DB), hexyloxypropylamine, poly(oxyethylene) diamine and tetrahydrofurfuryl alcohol (THFA); dimethylacetamide (DMAC), monoethanolamine, n-methylethanolamine, formamide, n-methyl formamide, gamma-butyrolactone, N-methylpyrrolidone, and the like. Still further solvents include dihydric and polyhydric alcohols such as diols and polyols such as (C₂-C₂₀) alkane diols and (C₃-C₂₀) alkane triols, cyclic alcohols and substituted alcohols. Particular examples of these organic polar solvents are propylene glycol, tetrahydrofurfuryl alcohol (THFA), diacetone alcohol and 1,4-cyclohexanedimethanol.

In certain embodiments, the organic solvent may be a glycol ether. The glycol ethers are typically water miscible and may include glycol mono(C₁-C₆)alkyl ethers and glycol di(C₁-C₆)alkyl ethers, such as but not limited to, (C₁-C₂₀)alkane diols, (C₁-C₆)alkyl ethers, and (C₁-C₂₀)alkane diol di(C₁-C₆)alkyl ethers. Examples of glycol ethers are ethylene glycol monomethyl ether, ethylene glycol monoethyl ether, ethylene glycol monobutyl ether, ethylene glycol dimethyl ether, ethylene glycol diethyl ether, diethylene glycol monomethyl ether, diethylene glycol monoethyl ether, diethylene glycol monopropyl ether, diethylene glycol monoisopropyl ether diethylene glycol monobutyl ether, diethylene glycol monoisobutyl ether, diethylene glycol monobenzyl ether, diethylene glycol dimethyl ether, diethylene glycol diethyl ether, triethylene glycol monomethyl ether, triethylene glycol dimethyl ether, polyethylene glycol monomethyl ether, diethylene glycol methyl ethyl ether, triethylene glycol ethylene glycol monomethyl ether acetate, ethylene glycol monoethyl ether acetate, propylene glycol monomethyl ether, propylene glycol dimethyl ether, propylene glycol monobutyl ether, propylene glycol, monoproply ether, dipropylene glycol monomethyl ether, dipropylene glycol monopropyl ether, dipropylene glycol monoisopropyl ether, dipropylene monobutyl ether, dipropyllene glycol diisopropyl ether, tripropylene glycol monomethyl ether, 1-methoxy-2-butanol, 2-methoxy-1-butanol, 2-methoxy-2-methylbutanol, 1,1-dimethoxyethane and 2-(2-butoxyethoxy) ethanol. More typical examples of glycol ethers are propylene glycol monomethyl ether, propylene glycol monopropyl ether, tri(propylene glycol) monomethyl ether and 2-(2-butoxyethoxy) ethanol.

In certain embodiments, the compositions can contain an organic amine. Exemplary amines include those represented by the formula: NR₁R₂R₃ wherein each R₁, R₂ and R₃ individually is selected from the group consisting of H, aliphatic group, ether group, alkylmonoamino group, alkyldiamino group, alkyltriamino group, and a N heterocyclic group optionally containing at least one additional hetero atom selected from the group consisting of N, O and S in the ring; or at least one quaternary ammonium compound represented by the formula: [NR₄R₅R₆R₇]⁻OH wherein each of R₄, R₅, R₆ and R₇ individually is an alkyl group. Suitable aliphatic groups include straight or branched chain alkyl groups, alkylene groups, alkyne, aryl, aryl-alkyl, alkyl-aryl and substituted aryl groups. Ether groups include acrylic ethers typically having 1-12 carbon atoms. Examples of some ether groups are methoxy, ethoxy, propoxy, butoxy, isopropoxy, isobutoxy, sec-butoxy and tert-butoxy. Amino groups may include primary, secondary and tertiary amines as well as higher alkyl amino functionality such as di- and tri-amines. Some examples of amines that can be used are the aminoalkylmorpholines such as aminopropylmorpholine and aminoalkylpiperazines such as aminoethylpiperazine.

Still further examples of an organic amine include hydroxylamines, organic amines such as primary, secondary or tertiary aliphatic amines, alicyclic amines, aromatic amines and heterocyclic amines, aqueous ammonia, and lower alkyl quaternary ammonium hydroxides. Specific examples of the hydroxylamines include hydroxylamine (NH.sub.2OH), N-methylhydroxylamine, N,N-dimethylhydroxylamine and N,N-diethylhydroxylamine. Specific examples of the primary aliphatic amines include monoethanolamine, ethylenediamine and 2-(2-aminoethylamino)ethanol. Specific examples of the secondary aliphatic amines include diethanolamine, N-methylaminoethanol, dipropylamine and 2-ethylaminoethanol. Specific examples of the tertiary aliphatic amines include dimethylaminoethanol and ethyldiethanolamine. Specific examples of the alicyclic amines include cyclohexylamine and dicyclohexylamine. Specific examples of the aromatic amines include benzylamine, dibenzylamine and N-methylbenzylamine. Specific examples of the heterocyclic amines include pyrrole, pyrrolidine, pyrrolidone, pyridine, morpholine, pyrazine, piperidine, N-hydroxyethylpiperidine, oxazole and thiazole. In other embodiments, the composition can contain a hydroxylamine. Examples of hydroxylamines are hydroxylamine (NH₂OH), diethylhydroxylamine and isopropylhydroxylamine.

Listed below are definitions of various terms used in this disclosure. These definitions apply to the terms as they are used throughout this specification, unless otherwise limited in specific instances, either individually or as part of a larger group.

The term “alkyl” refers to straight or branched chain unsubstituted hydrocarbon groups of 1 to 20 carbon atoms, more typically 1 to 8 carbon atoms. The expression “lower alkyl” refers to alkyl groups of 1 to 4 carbon atoms. Examples of suitable alkyl groups include methyl, ethyl and propyl.

The terms “alkenyl” and “alkynyl” refer to straight or branched chain unsaturated hydrocarbon groups typically having 2 to 8 carbon atoms.

The term “aryl” refers to monocyclic or bicyclic aromatic hydrocarbon groups having 6 to 12 carbon atoms in the ring portion, such as phenyl, naphthyl, biphenyl and diphenyl groups, each of which may be substituted.

Examples of some monocyclic heterocyclic groups typically contain 5 or 6 atoms in the ring and include morpholino, piperazine, isothiazole, imidazoline, pyrazoline, pyrazolidine, pyrimidine, pyrazine.

The term “aralkyl” or “alkylaryl” refers to an aryl group bonded directly to an alkyl group, such as benzyl or phenethyl. The term “substituted aryl” or “substituted alkylaryl” refers to an aryl group or alkylaryl group substituted by, for example, one to four substituents such as alkyl; substituted alkyl, halo, trifluoromethoxy, trifluoromethyl, hydroxy, alkoxy, azido, cycloalkyloxy, heterocyclooxy, alkanoyl, alkanoyloxy, amino, alkylamino, aralkylamino, hydroxyalkyl, aminoalkyl, azidoalkyl, alkenyl, alkynyl, allenyl, cycloalkylamino, heterocycloamino, dialkylamino, thiol, alkylthio, cycloalkylthio, heterocyclothio, ureido, nitro, cyano, carboxy, carboxyalkyl, carbamyl, alkoxycarbonyl, alkylthiono, arylthiono, alkylsulfonyl, sulfonamide, aryloxy and the like. The substituent may be further substituted by halo, hydroxy, alkyl, alkoxy, aryl, substituted aryl, substituted alkyl or aralkyl. “Substituted benzyl” refers to a benzyl group substituted by, for example, any of the groups listed above for substituted aryl.

The composition may optionally contain water such as up to about 40% by weight of water, or up to about 35% by weight of water or up to about 10% by weight of water. It can be present coincidentally as a component of other elements such as, for example, an aqueous hydroxylamine solution or it can be added separately. In certain embodiments, the water to be added is deionized water.

The composition may also include one or more of the following additives: surfactants, chelating agents, chemical modifiers, dyes, biocides, and other additives. Some examples of representative auxiliary additives include acetylenic alcohols and derivatives thereof, acetylenic diols (non-ionic alkoxylated and/or self-emulsifiable acetylenic diol surfactants) and derivatives thereof, alcohols, amides (including aprotic solvents such as dimethyl formamide and dimethyl acetamide), and chelating agents such as beta-diketones, beta-ketoimines, carboxylic acids, mallic acid and tartaric acid based esters and diesters and drivatives thereof.

Some exemplary compositions in which the tannic acid can be used as a corrosion inhibitor are disclosed in U.S. patent application Ser. No. 10/443,867 entitled “Composition Suitable for Removing Photoresist, Photoresist Byproducts and Etching Residues to Reiker et al, filed May 23, 2003, entire disclosure of which is incorporated herein by reference.

Examples of substrates from which the compositions of the present invention remove photoresists and/or post etch residues without attacking the substrates themselves include metal substrates such as aluminum/titanium/tungsten, and aluminum/silicon, aluminum/silicon/copper; and substrates such as silicon oxide, silicon nitride, and gallium/arsenide.

The method of removing photoresist and/or post etch residues can include applying a photoresist onto a substrate to provide a photoresists layer; exposing the applied photoresist layer to light through a mask pattern and developing the exposed photoresist layer in the usual manner to form a photoresist pattern; the substrate through the photoresist pattern by a known procedure; optionally performing another modification treatment such as ashing or ion implantation; and contacting the substrate with the resist composition of the invention by suitable means such as immersion.

The following non-limiting examples are presented for purposes of illustrating particular embodiments but are by no means intended to limit the disclosure.

The following exemplary compositions, 1 through 6, were prepared and their formulations are presented in Table I. In Table I, all amounts are given in weight percent and add up to 100 weight percent.

TABLE I

| Example 1 | | Example 2 | | Example 3 | |
|---|---|---|---|---|---|
| Components | Wt. % | Components | Wt. % | Components | Wt. % |
| Dimethyl Sulfoxide (DMSO) | 27.00% | Propylene Glycol (PG) | 39.75% | Diethylhydroxylamine (DEHA) | 15.00% |
| Monoethanolamine (MEA) | 69.90% | Aminopropylmorpholine (APM) | 25.25% | Aminopropylmorpholine (APM) | 54.40% |
| FC170C(a fluorinated surfactant) | 0.10% | Hydroxylamine (50%) | 20.00% | Hydroxylamine (50%) | 10.00% |
| Tannic Acid | 3.00% | Water | 17.00% | Water | 17.00% |
| | | Tannic Acid | 3.00% | Tannic Acid | 3.00% |
| Example 4 | | Comparative Example 5 | | Comparative Example 6 | |
| Components | Wt. % | Components | Wt. % | Components | Wt. % |
| Monoethanolamine (MEA) | 59.20 | Monoethanolamine (MEA) | 59.20 | Monoethanolamine (MEA) | 63.90 |
| Hydroxylamine (50%) | 36.10 | Hydroxylamine (50%) | 36.10 | Hydroxylamine (50%) | 36.10 |
| Tannic Acid | 4.70 | Cathecol | 4.70 | | |

Each exemplary composition was tested to determine, inter alia, the ability of the tannic acid and/or salt thereof as an inhibitor to prevent corrosion when exposed to the exemplary formulations. Metal etch rates were determined using a CDE ResMap 273 Four Point Probe. An amount of 500 mls of each exemplary was placed in a beaker with stirring and heated, if required to the specified temperature. If the metal to be tested was titanium, an initial dip in phosphoric acid was required. The initial thickness of a wafer was determined using the CDE ResMap 273 Four Point Probe. After determining the initial thickness, test wafers were immersed in the exemplary composition at a temperature of 75° C. The test wafers were an Al/Cu alloy with 4% Cu, or titanium was zero-valent titanium. At specified time intervals, the test wafers were removed from the exemplary composition, rinsed with deionized water and dried under nitrogen. The thickness of each wafer was measured by means of a four-point probe. The etch rate results expressed in Å/min of aluminum and titanium are provided in Table II.

TABLE II

| | Exam- | Exam- | Exam- | Exam- | Comp. | Comp. |
|---|---|---|---|---|---|---|
| | ple 1 | ple 2 | ple 3 | ple 4 | Ex. 5 | Ex. 6 |
| Aluminum | 1.85 | 0.28 | 0.89 | 2.66 | 10 | 63 |
| Titanium | 0.04 | 2.33 | 0.09 | 9.71 | 20 | 104 |

The results in Table II illustrate that the compositions containing tannic acid and/or salt thereof, or exemplary compositions 1 through 4, exhibited significantly enhanced corrosion prevention when compared to similar compositions containing another corrosion inhibitor or no corrosion inhibitor.

What is claimed:

1. A composition for removing residue, the composition comprising:
an organic amine;
optionally an organic solvent; and
at least about 0.5% by weight of tannic acid or salt thereof or both.

2. The composition of claim 1 wherein the composition comprises from about 0.5 to about 25% by weight of tannic acid or salt thereof or both.

3. The composition of claim 1 wherein the composition comprises from about 0.5 to about 10% by weight of tannic acid or salt thereof or both.

4. The composition of claim 1 wherein the the composition comprises from about 0.5 to about 5% by weight of tannic acid or salt thereof or both.

5. The composition of claim 1 wherein the composition comprises an organic solvent.

6. The composition of claim 1 wherein the organic amine comprises hydroxylamine.

7. The composition of claim 1 wherein the organic amine comprise at least one amine represented by the formula: NR₁R₂R₃ wherein each of R₁, R₂ and R₃ individually is selected from the group consisting of H, aliphatic group, ether group, amino group and aryl group, and an N heterocyclic group optionally containing at least one additional hetero atom selected from the group consisting of N, O and S in the ring; or at least one quaternary ammonium compound represented by the formula [NR₄R₅R₆R₇]OH wherein each of R₄, R₅, R₆ and R₇ individually is an alkyl group.

8. The composition of claim 7 which further comprises a hydroxylamine.

9. The composition of claim 1 wherein the organic amine comprises an aminoalkylmorpholine.

10. The composition of claim 9 wherein the organic amine comprises aminopropylmorpholine.

11. The composition of claim 9 which further comprises a hydroxylamine.

12. The composition of claim 5 wherein the organic solvent comprises propylene glycol.

13. The composition of claim 5 wherein the organic solvent comprises an alkanolamine.

14. The composition of claim 5 wherein the organic solvent comprises dimethyl sulfoxide.

15. The composition of claim 1 which further comprises water.

16. The composition of claim 1 which has a pH of at least 7.

17. The composition of claim 1 which has a pH of at least about 9.

18. The composition of claim 1 which has a pH of about 10 to about 12.

19. A method for removing photoresist or etching residue or both from a substrate wherein comprises contacting said substrate with a composition comprising:
an organic amine;
optionally an organic solvent; and
at least about 0.5% by weight of tannic acid or salt thereof or both.

20. A method for defining a pattern wherein comprises coating a photoresist onto a substrate,
lithographically defining a pattern on the photoresist;
transferring the pattern the substrate;
removing photoresist or etching residue or both from the substrate by contacting the substrate with a composition that comprises:
an organic amine;
optionally an organic solvent; and
at least about 0.5% by weight of tannic acid or salt thereof or both.
